(19) United States
(12) Patent Application Publication
(10) Pub. No.: US 2015/0366232 A1
(43) Pub. Date: Dec. 24, 2015

(54) Compositions And Methods For Producing A High Protein Curd Composition

(71) Applicant: Dean Foods Company, Dallas, TX (US)

(72) Inventors: Benjamin Hall, Broomfield, CO (US); Dean A. Lippold, Boulder, CO (US); Bryan C. Shipplett, Broomfield, CO (US)

(21) Appl. No.: 14/745,131

(22) Filed: Jun. 19, 2015

Related U.S. Application Data
(60) Provisional application No. 62/014,446, filed on Jun. 19, 2014.

(51) Int. Cl. A23C 19/00

(52) U.S. Cl. CPC A23C 19/00

(57) ABSTRACT

Embodiments of the present disclosure generally relate to compositions and methods for producing high protein dairy products. In certain embodiments, the present disclosure provides compositions and methods for producing fully homogenized high protein, low fat dairy products from curd. Given the commercial and nutritional value of dairy products, embodiments of the present disclosure address the need for dairy products having high protein content and improved organoleptic properties.

### RELATED APPLICATIONS

This non-provisional patent application claims priority to U.S. Provisional Patent Application Ser. No. 62/014,446, filed Jun. 19, 2014, which is incorporated herein in its entirety for all purposes.

### FIELD

Embodiments of the present disclosure generally relate to compositions and methods for producing high protein dairy products. In certain embodiments, the present disclosure provides compositions and methods for producing fully homogenized high protein, low fat dairy products from curd.

### BACKGROUND

People have been consuming the milk of domesticated animals for thousands of years. However, with the industrialization and urbanization of society, supplying dairy products became a commercial industry, thus giving more people access to this valuable type of nutrition. Currently, about one-third of the U.S. milk supply is actually processed into milk and cream products; the remaining two-thirds of the milk supply is used to manufacture a wide range of dairy products. Sales of these dairy products, such as butter, cheese, ice cream and yogurt, account for tens of billions of dollars annually in the U.S.

With such high demand, people involved in the dairy industry have begun to explore alternative ways to improve both the efficiency of producing and providing dairy products to more people worldwide. Additionally, there has been an increased focus in the dairy industry to provide alternative products for consumers that address some of the nutritional and organoleptic shortcomings of currently available dairy products. Advances in food science have provided the means to research ways to improve the nutritional content and organoleptic properties of dairy products to satisfy an increasingly demanding consumer market.

### SUMMARY

Typically, in order to satisfy consumer demand, it has been necessary to add extraneous ingredients to dairy products, such as sugar and fat. However, there is an increasing demand for more natural dairy products that have high protein content, low fat content, and appealing organoleptic properties, without the need to add extraneous ingredients.

Embodiments of the present disclosure include a high-protein, low-fat dairy product composition comprising at least one curd component comprising curds with particle sizes between about 0.1 mm to about 3.0 mm in diameter and a protein content greater than about 10%, and at least one softening agent having a viscosity less than about 300,000 centipoise. In accordance with these embodiments, the at least on softening agent and the at least one curd component are combined into a mixture and milled to produce a fully homogenized dairy product composition having a protein content greater than about 5%, curds with particle sizes less than about 100 μm in diameter, and an overrun less than about 50%.

In some embodiments, the curd component has a protein content between about 10% and about 25%, a whey content that is not greater than about 50%, and a fat content that is not greater than about 5%. In other embodiments, the curd component has a density between about 7.0 lbs/gal and about 10.0 lbs/gal, a pH between about 4.0 and about 6.0, and comprises precipitated casein.

In some embodiments, the softening agent has a protein content between about 0% and about 50%, a density between about 5.0 lbs/gal and 15.0 lbs/gal, and a pH between about 2.0 and about 9.0. In other embodiments, the softening agent comprises one or more of fruit juice, fruit preparation, milk, flavored milk, oils and fats.

In some embodiments, the fully homogenized dairy product composition has a protein content between about 5% and about 20%, a whey content that is not greater than about 50%, and a fat content that is not greater than about 4%. In other embodiments, the fully homogenized dairy product composition has a protein-to-fat ratio between about 1:0.001 to about 1:1. In other embodiments, the fully homogenized dairy product composition comprises precipitated casein, has a density between about 5.0 lbs/gal and about 10.0 lbs/gal, a pH between about 4.0 and about 6.0, and curds with particle sizes less than about 40 μm in diameter. In still other embodiments, the fully homogenized dairy product composition further comprises one or more of gums, texturizing agents, mouth coating agents, emulsifiers, thickening agents, coloring agents, fat sources, flavorings (natural or artificial), preservatives, bulking agents, acidity regulators, fillers, vitamins, minerals and nutritional supplements.

Embodiments of the present disclosure also include a method of producing a homogenized dairy product. The method includes combining at least one curd component comprising curds with particle sizes between about 0.1 mm to about 3.0 mm in diameter, and a protein content greater than about 10%, with at least one softening agent having a viscosity less than about 300,000 centipoise to form a mixture. The method also includes subjecting the mixture to a milling process sufficient to produce a fully homogenized diary product having a protein content greater than 5% and an overrun less than about 50%.

In some embodiments, the milling process includes subjecting the mixture of the at least one curd component and the at least one softening agent to shear stress, subjecting the mixture of the at least one curd component and the at least one softening agent to temperatures between about 30° F. and about 150° F., and subjecting the mixture of the at least one curd component and the at least one softening agent to pressures between about 100 psi and about 5,000 psi.

The terms “curd,” “cheese curd,” “cottage cheese curd,” and modifications and derivatives thereof generally refer to substances made from milk or milk products in which casein has been precipitated.

The terms “homogenized,” “fully homogenized,” “homogeneous” and modifications and derivatives thereof generally refer to substances or mixtures having components that are generally uniformly sized and generally uniformly distributed throughout the substance or mixture.

The term “overrun,” “overrun percentage,” and modifications and derivatives thereof generally refer to the percentage of air incorporated into a substance or mixture (also referred to as aeration).

The terms “determine,” “calculate,” and “compute,” and variations thereof, as used herein, are used interchangeably and include any type of methodology, process, mathematical operation or technique.

It is to be noted that the term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. The various characteristics mentioned above, as well as other features and characteristics described in more detail herein will be readily apparent to those skilled in the art with the aid of the present disclosure upon reading the following detailed description of the embodiments.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “means” as used herein shall be given its broadest possible interpretation in accordance with 35 U.S.C. §112(f). Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a representative flow diagram of a method of producing a high protein dairy product, according to one embodiment of the present disclosure.

FIG. 2 is a representative flow diagram of a detailed production process for generating a high protein dairy product from curd, according to one embodiment of the present disclosure.

### DETAILED DESCRIPTION

Embodiments of the present disclosure generally relate to compositions and methods for producing high protein dairy products. In certain embodiments, the present disclosure provides compositions and methods for producing fully homogenized high protein, low fat dairy products from curd.

Embodiments of the present disclosure relate to a high protein, low fat dairy product composition comprising a curd component, such as a cheese curd, that is 100% homogeneous and contains no visible curd particles. The unaided human eye is generally able to visualize particles beginning in the range of about 40 μm to about 100 μm in diameter, and possibly in the range of about 40 μm to about 60 μm in diameter. The unaided human eye, therefore, is unable to see curd particles less than the range of 40 μm to about 100 μm, and possibly less than the range of about 40 μm to about 60 μm. For the purposes of this disclosure, it may be desirable for the high protein, low fat dairy product composition to have a curd component having a diameter equal to or less than about 100 μm, 60 μm or 40 μm. For example, it may be desirable for the curd component to have a diameter size less than about 100 μm, 99 μm, 98 μm, 97 μm . . . 43 μm. 42 μm, 41 μm, or 40 μm, or any increment thereof, such as increments of 0.1 μm. In some cases, having no visible curd particles in the composition indicates that the particle size of the curd component is less than about 100 μm in diameter. In some cases, having no visible curd particles in the composition indicates that the particle size of the curd component is less than about 60 μm. In other cases, having no visible curd particles in the composition indicates that the particle size of the curd component is less than about 40 μm. As one of skill in the art would recognize, individual particles may not have a perfect spherical shape. Accordingly, since the particular size and shape of a particle may be irregular, and diameters of those irregularly shaped particles may vary.

In addition, embodiments of the high protein, low fat dairy product composition are homogenized or homogeneous. The terms “homogenized,” “fully homogenized,” “homogeneous” and modifications and derivatives thereof generally refer to substances or mixtures having components that are generally uniformly sized and generally uniformly distributed throughout the substance or mixture. It may difficult to measure homogeneity, but for the purpose of this disclosure a composition is fully homogenized or homogeneous when 90.0% to 100% of the curd component of the dairy product composition is not visible to the unaided human eye. For example, 90%, 91%, 92%, 93%, 94%, 95%, 96%, 97%, 98%, 99% or 100% of the curd component of the dairy product composition is not visible to the unaided human eye. Stated differently, a fully homogenized or homogenous composition includes 10% or less (e.g., 9%, 8%, 7% . . . 2%, 1% or 0%) of the curd component within the dairy product composition being visible to the unaided human eye.

The curd component of the dairy product composition, as well as other components (e.g., softening agent(s)), are processed such that they result in a product having components that are fully homogenized or homogenous throughout the product. Generally, a product that is fully homogenous indicates that it has enhanced organoleptic properties, such as smoothness, creaminess, and a lack of undesirable chunks. The dairy product composition may have a body and texture similar to that of yogurt, but with a higher protein and lower fat content.

In some cases, after processing, embodiments of the high protein, low fat dairy product composition can have a certain degree of aeration, or overrun. Generally, the term “overrun,” “overrun percentage,” and modifications and derivatives thereof generally refer to the percentage of air incorporated into a substance or mixture (also referred to as aeration). As with the degree of homogenization, a product having a certain degree of overrun or aeration can indicate that it has enhanced organoleptic properties, such as smoothness, creaminess, airiness, and a lack of undesirable chunks. Embodiments of the high protein, low fat dairy product composition can have an overrun percentage that is less than about 50.0%. For example, the overrun percentage can be 49.0%, 48.0%, 47.0%, 46.0% . . . 4%, 3%, 2%, 1% or 0%, or any increment thereof, such as increments of 0.1% or 0.01%. In some cases, the composition can have an overrun between about 10.0% and about 50.0%. In some cases, the composition can have an overrun between about 10.0% and about 40.0%. In some cases, the composition can have an overrun about 20.0% and about 40.0%. In still other cases, the composition can have an overrun between about 25.0% and about 35.0%.

In some embodiments, the high protein, low fat dairy product composition can have a certain density, such as, for example, a density between about 5.0 and about 10.0 pounds per gallon (lbs/gal). For example, the high protein, low fat dairy product composition can have a density of 5%, 6%, 7%, 8%, 9% or 10%, or any increment thereof, such as increments of 0.1% or 0.01%. In some cases, the composition can have a density between about 5.0 and about 9.0 lbs/gal. In some cases, the composition can have a density between about 5.0 and about 8.0 lbs/gal. In some cases, the composition can have a density between about 5.0 and about 7.0 lbs/gal. In some cases, the composition can have a density between about 5.0 and about 6.0 lbs/gal. The exact density of the composition can vary depending on a number of factors, including but not limited to, processing conditions, the degree of overrun, and/or the density of the curd component.

Embodiments of the dairy product composition of the present disclosure are also high in protein content. Typically, dairy products contain less than 5.0% protein, and are not generally considered to be a high protein source. However, compositions of the present disclosure can have an overall protein content that is equal to or greater than about 5.0%, 6.0%, 7.0%, 8.0%, 9.0%, 10.0%, 11.0%, 12.0%, 13.0%, 14.0%, 15.0%, 16%, 17%, 18%, 19%, 20%, 21%, 22%, 23%, 24,%, 25% or higher, or any %, or any increment thereof, such as increments of 0.1% or 0.01%. In some cases, the composition can have a protein content between about 5.0% and about 10.0%. In some cases, the composition can have a protein content between about 6.0% and about 15.0%. In some cases, the composition can have a protein content between about 8.0% and about 20.0%. In some cases, the composition can have a protein content between about 10.0% and about 25.0%. In some cases, the composition can have a protein content between about 10.0% and about 20.0%. In some cases, the composition can have a protein content between about 6.0% and about 15.0%.

Embodiments of the dairy product composition of the present disclosure can also be high in protein content but low in fat content. For example, embodiments of the composition can have an overall fat content that is not greater than about 5.0%. For example, the overall fat content of the dairy product composition can be equal to or less than 5.0%, 4.0%, 3.0%, 2.0%, 1.0% or 0%, or any increment thereof, such as increments of 0.1% or 0.01%. In some cases, the composition can have a fat content that is between about 0.0% and about 5.0%. In some cases, the composition can have a fat content that is between about 0.0% and about 4.0%. In other cases, the composition can have a fat content that is between about 2.0% and about 4.0%. In some embodiments, the composition can have a certain protein-to-fat ratio. Also, the protein-to-fat ratio of the composition can be between about 1:0.0001 to about 1:1, depending on the product being made. For example, the protein-to-fat ratio of the dairy product composition can be 1:0.0, 1:0.0001, 1:0.0002, 1:0.0003, 1:0.0004, 1:0005 . . . 1:0.995, 1:0,996, 1:0.997, 1:0998, 1:0999, and 1:1, or any increments thereof. In some cases, the protein-to-fat ratio can be about 1:0.001. In some cases, the protein-to-fat ratio can be about 1:0.01. In some cases, the protein-to-fat ratio can be about 1:0.1. In some cases, the composition can have a fat content that is substantially zero such that the product is essentially fat free.

Embodiments of the dairy product compositions of the present disclosure generally include at least one curd component and at least one softening agent(s). During processing of the dairy composition of the present disclosure, at least one softening agent is combined with at least one curd component to produce a mixture from with the composition is made. In some cases, the curd component comprises one or more cheese curds. The terms “curd,” “cheese curd,” “cottage cheese curd,” and modifications and derivatives thereof generally refer to substances made from milk or milk products in which casein has been precipitated. As would be recognized by one of ordinary skill based on the present disclosure, cheese curds (e.g., cottage cheese curds) can be produced from milk (e.g., low-fat milk, skim milk, etc.) using a variety of processes.

In one process, milk can be acidified to precipitate the casein. In this process, milk can be treated with acid to lower the pH to about 4.6, resulting in the precipitation of casein proteins from the milk to form the curd which can then be used to make the dairy compositions described above. Another process involves the fermentation of milk with cheese cultures to lower the pH to 4.6 and precipitate the casein proteins from the milk to form the curd. In another method, precipitation of the casein is accomplished using a rennet enzyme rather than acid. Generally, the dairy product composition of the present disclosure can has a pH ranging from about 4.0 and about 6.0. For example, the dairy product composition can have a pH of 4.0, 5.0, or 6.0, or any increments thereof, such as 0.1 or 0.01. In some cases, the composition has a pH ranging from about 4.2 to about 5.5.

Additionally, the more solid casein proteins precipitated as curd can be separated from milk using high-speed centrifugation, leaving the more liquid whey proteins and dissolved constituents in solution. These methods may be combined, as would be recognized by one of ordinary skill in the art based on the present disclosure. The resulting curds can be further treated, including but not limited to being cut, cooked, drained, and/or washed to remove the whey, for example. The curds can be pressed or not pressed; if not pressed, the curds generally resemble loose curds residing in some residual whey. In some cases, the dairy product composition of the present disclosure can have a whey content that is not greater than 50.0%. In some cases, the composition can have a whey content that is not greater than 25.0%. In some cases, the composition can have a whey content that is not greater than 10.0%. In some cases, the composition can have little to no whey content. The composition can, therefore, have a whey content of 0.0%, 1.0%, 2.0%, 3.0%, 4.0%, 5%, . . . 46%, 47%, 48%, 49%, or 50%, or any increments thereof, such as 0.1 or 0.01%.

In some embodiments, the curd component of the present disclosure comprises predominately precipitated casein, and prior to processing (e.g., milling, shearing, etc.), the curd component comprises curds with particle sizes between about 0.1 mm to about 20.0 mm in diameter. For example, the diameter of the curd particle size may be 0.1 mm, 0.2 mm, 0.3 mm, 0.4 mm, 0.5 mm, 0.6 mm, 0.7 mm, 0.8 mm, 0.9 mm, 1.0 mm, . . . , 19.0 mm, 19.1 mm, 19.2 mm, 19.3 mm, 19.4 mm, 19.5 mm, 19.6 mm, 19.7 mm, 19.8 mm, 19.9 mm or 20.0 mm, or any increment thereof, such as 0.1 or 0.01 mm. In some cases, the curd particle sizes are between about 0.5 mm and about 3.0 mm. In some cases, the curd particle sizes are between about 1.0 mm and about 3.0 mm. In some cases, the curd particle sizes are between about 2.0 mm and about 3.0 mm. In some cases, the curd particle sizes are between about 1.0 and about 2.0 mm. As mentioned, the curd component is predominately casein, and the overall protein content of the curd component can be greater than about 5.0%.

Embodiments of the curd component of the present disclosure can also be high in protein content but low in fat content. For example, as discussed above, embodiments of the curd component can have an overall fat content that is not greater than about 5.0%. In some cases, the curd component can have a fat content that is between about 0.0% and about 5.0%. In some cases, the curd component can have a fat content that is between about 0.0% and about 4.0%. In other cases, the curd component can have a fat content that is between about 2.0% and about 4.0%. In some embodiments, the curd component can have a certain protein-to-fat ratio. For example, as discussed above, the protein-to-fat ratio of the curd component can be between about 1:0.0001 to about 1:1, depending on the product being made. In some cases, the protein-to-fat ratio can be about 1:0.001. In some cases, the protein-to-fat ratio can be about 1:0.01. In some cases, the protein-to-fat ratio can be about 1:0.1. In some cases, the curd component can have a fat content that is substantially zero such that the product is essentially fat free.

In some embodiments, the curd component can have a certain density, such as, for example, a density between about 7.0 and about 10.0 pounds per gallon (lbs/gal). For example, the density can be 7.0, 8.0, 9.0 or 10.0 pounds per gallon (lbs/gal), or any increment thereof, including 0.1 or 0.01 lbs/gal. In some cases, the curd component can have a density between about 7.0 and about 9.0 lbs/gal. In some cases, the curd component can have a density between about 7.0 and about 8.0 lbs/gal. In some cases, the curd component can have a density between about 8.0 and about 10.0 lbs/gal. In some cases, the curd component can have a density between about 8.0 and about 9.0 lbs/gal. The exact density of the composition can vary depending on a number of factors, including but not limited to, the method and/or conditions used to precipitate the casein, and/or the type of milk being used as the source of the curd component. Generally, the curd component is not fully homogeneous or homogenized due to the precipitated casein and the residual whey protein. The texture of the curd component is generally chunky and undesirable until combined with one or more softening agents and further processed.

Softening agents generally help to reduce the density of the curd component and maintain the final dairy product composition as a homogeneous emulsion. Embodiments of softening agents include, but are not limited to, one or more of a fruit juice, a fruit preparation, milk, flavored milk, oils, fats, and the like. In some embodiments, suitable softening agent can have a pH between about 2.0 and about 9.0. For example, the softening agent can have a pH of 2.0, 3.0, 4.0, 5.0, 6.0, 7.0, 8.0 or 9.0, or any increment thereof, such as 0.1 or 0.01.

Other suitable softening agents used to make the dairy product composition of the present disclosure can include any substances having a viscosity less than about 300,000 centipoise (cPs). The specific softening agent chosen will depend on various factors, including the final dairy product composition that is desired, as would be recognized by one of ordinary skill in the art based on the present disclosure. The softening agent can be selected to have a protein content between about 0.0% and about 50.0%. For example, the softening agent may have a protein content of 0.0%, 1.0%, 2.0%, 3.0%, 4.0%, 5.0%, . . . 45%, 46%, 47%, 48%, 49% or 50.0%, or any increment thereof, such as 0.1 or 0.01%. In some embodiments, the softening agent can have a density between about 5.0 lbs/gal and 15.0 lbs/gal. For example, the softening agent can have a density of 5.0 lbs/gal, 6 lbs/gal, 7 lbs/gal, 8 lbs/gal, 9 lbs/gal, 10 lbs/gal, 11 lbs/gal, 12 lbs/gal, 13 lbs/gal, 14 lbs/gal or 15.0 lbs/gal, or any increment thereof, such as 0.1 or 0.01%. In some cases, the softening agent can have a density between about 5.0 and about 14.0 lbs/gal. In some cases, the softening agent can have a density between about 5.0 and about 13.0 lbs/gal. In some cases, the softening agent can have a density between about 5.0 and about 12.0 lbs/gal. In some cases, the softening agent can have a density between about 5.0 and about 11.0 lbs/gal. In some cases, the softening agent can have a density between about 5.0 and about 10.0 lbs/gal. In some cases, the softening agent can have a density between about 8.0 and about 15.0 lbs/gal. In some cases, the softening agent can have a density between about 10.0 and about 15.0 lbs/gal. In some cases, the softening agent can have a density between about 10.0 and about 12.0 lbs/gal.

Embodiments of the present disclosure also include a method of producing a homogenized dairy product having a high protein and low fat content. The method includes combining at least one curd component, as described above, with at least one softening agent, as described above, to form a mixture. The method also includes subjecting the mixture to a milling process sufficient to produce a fully homogenized diary product having the nutritional characteristics and organoleptic properties, as described above.

In some embodiments, the milling process includes subjecting the mixture of the at least one curd component and the at least one softening agent to shear stress. In some, embodiments, shear stress is provided by passing the mixture through a shearing pump, mill, or colloid mill. In the process described herein, there may not be a whey separation step in preparing the spreadable product of the invention once the mixture is milled. Therefore, the components of the mix can be selected so as to provide the desired level of moisture, protein, fat and salt in the finished product.

The milling process may comprise any suitable methods and equipment sufficient to combine the curd component and the softening agent, along with any additional components, to form a fully homogenized product. The milling process may be configured to reduce the curd size of the curds comprising the curd component such that individual curds are not visible (e.g., less than about 100 μm). In some cases, the milling process may reduce the sizes of the curds sufficiently so that the curds are not distinguishable in the final dairy product composition (e.g., the product comprises a smooth, creamy, homogeneous texture).

The curd component and the softening agent may be combined prior to entering into a milling process, or the curd component and the softening agent can be combined through different inlets to the milling process. In some cases, additional components may be added to the mixture of the curd component and the softening agent prior to, during, and/or after combining curd component and the softening agent (e.g., during milling and/or after milling). Additional components may include, but are not limited to, one or more of gums, texturizing agents, mouth coating agents, emulsifiers, thickening agents, coloring agents, fat sources, flavorings (natural or artificial), preservatives, bulking agents, acidity regulators, fillers, vitamins, minerals and nutritional supplements, and the like. The gums, texturizing agents, and mouth coating agents may affect the final texture and mouthfeel of the final dairy product composition. The gums, texturizing agents, and mouth coating agents can include, but are not limited to, locust bean gum, xanthan gum, guar gum, gelatins, carboxymethylcellulose, and the like.

Emulsifiers can also be added to the dairy product composition to aid in emulsifying the final product as well as maintaining the final product as a stable emulsion. Various emulsifiers can include, but are not limited to, one or more mono- and diglycerides of fatty acids, acetic and fatty acid esters of glycerol, lactic and fatty acid esters of glycerol, citric acid esters, citric and fatty acid esters of glycerol, diacetyltartaric and fatty acid esters of glycerol, polyglycerol esters of fatty acids, mixed tartaric, acetic and fatty acid esters of glycerol, sucrose esters of fatty acids, propylene glycol esters of fatty acids, sorbitan monostearate, sorbitan tristearate, polyoxy sorbitan esters, and/or polysorbates (such as polysorbate 80, 60 or 65) and lecithins. Thickening agents may affect the final thickness of the product and can include, but are not limited to, various starches. Fat sources may be used to adjust the final fat content (and thereby the texture, mouthfeel, etc.) of the final dairy product composition independently of the selection of the curd component and softening agent. Various fat sources can include any dairy fat source such as cream. Various other optional additives may be included to provide a final dairy product composition having the desired nutritional characteristics and organoleptic properties.

The milling process may utilize various devices or mills capable of imparting shear stress in order to reduce the particle sizes of the curds in the curd component, as well as to fully homogenize the mixture of the curd component and the softening agent. Suitable devices can include, but are not limited to, shearing pumps, shearing mills, colloid mills, and the like. Various devices used to homogenize the mixture may also be used, but the devices may be operated a pressure or speed below that necessary to fully homogenize the mixture. For example, the milling process may be conducted using a device that subjects the mixture of the at least one curd component and the at least one softening agent to shear stress at temperatures between about 30° F. and about 150° F. (e.g., 31° F., 32° F., 33° F., 34° F., 35° F., . . . , 145° F., 146° F., 147° F., 148° F., 149° F., 150° F., or any increment thereof, such as 0.1° F. or, 0.01° F.), and at pressures between about 100 psi and about 5,000 psi (e.g., 100 psi, 101 psi, 102 psi, 103 psi, 104 psi, 105 psi, . . . , 4,995 psi, 4996 psi, 4997 psi, 4998 psi, 4999 psi, or 5,000 psi, or any increment thereof, such as 0.1 psi or, 0.01 psi). In some cases, the milling process can be conducted at temperatures between about 40° F. and about 140° F. In some cases, the milling process can be conducted at temperatures between about 50° F. and about 120° F. In some cases, the milling process can be conducted at temperatures between about 60° F. and about 100° F. In some cases, the milling process can be conducted at temperatures between about 80° F. and about 150° F. In some cases, the milling process can be conducted at temperatures between about 100° F. and about 150° F. In some cases, the milling process can be conducted at temperatures between about 120° F. and about 150° F. In some cases, the milling process can be conducted at pressures between about 200 psi and about 4,500 psi. In some cases, the milling process can be conducted at pressures between about 300 psi and about 4,000 psi. In some cases, the milling process can be conducted at pressures between about 500 psi and about 3,500 psi. In some cases, the milling process can be conducted at pressures between about 1,000 psi and about 3,000 psi. In some cases, the milling process can be conducted at pressures between about 2,000 psi and about 3,000 psi. In some cases, the milling process can be conducted at pressures between about 2,000 psi and about 4,000 psi. In some cases, the milling process can be conducted at pressures between about 2,000 psi and about 5,000 psi. Specific milling conditions will vary depending on a variety of factors; however, in one example, the curd component and the softening agent can be milled using devises having the specifications in Table 1.

TABLE 1
Example milling specifications

| | | | Rotor | | |
|---|---|---|---|---|---|
| | Motor | 60 Hz Speed | Diameter | Volume | Tip Speed |
| | HP | (RPM) | (inches) | (gallons) | (meters/sec) |
| Device 1 | 10 | 3450 | 4.25 | 85 | 19.51 |
| Device 2 | 15 | 3450 | 4.25 | 205 | 19.51 |
| Device 3 | 25 | 3450 | 5 | 160 | 22.95 |
| Device 4 | 30 | 3450 | 5 | 365 | 22.95 |
| Device 5 | 30 | 1750 | 8 | 500 | 18.63 |
| Device 6 | 40 | 1750 | 8 | 1150 | 18.63 |
| Device 7 | 50 | 1750 | 9 | 825 | 20.95 |
| Device 8 | 75 | 1750 | 9 | 2000 | 20.95 |

The milling process can comprise using a shearing pump or mill. In such an exemplary device, the mixture of the curd component and the softening agent is sheared by forcing the mixture through small orifices or between closely clearing but relatively fixed surfaces. Similarly, in a colloid mill, the mixture can be subjected to shearing action by passing the mixture between two surfaces that move at high velocity and at close clearance to each other. The pressure established during the pre-homogenization step can be within the range of from about 5.0 psig to about 500.0 psig. Other devices may also be suitable. For example, the mixture of the curd component and the softening agent can be pumped through a conduit provided with a valve. The valve can be partially closed to establish a back pressure on the mixture as it is pumped through the conduit. The valve can be set to establish a back pressure of from about 5.0 psig to about 100.0 psig. A positive displacement pump can be used to drive the mixture, and the shearing action can occur in the pump, the valve, or both. In such an embodiment, suitable valves can include, but are not limited to, gate valves, globe valves, needle valves, diaphragm valves, and the like.

The configuration of the milling device can affect the nutritional characteristics and the organoleptic properties of the final dairy product composition. For example, the pressure at which the milling stage is carried out can affect the degree of milling. At a sufficiently high pressure, the mixture can be homogenized to a degree which may affect the firmness and texture of the final product. When the pressure is insufficient, for example, the curd size of the curd component may not be sufficiently reduced to the desired sizes (e.g., below that which is visible).

Once the mixture passes through the milling stage, the resulting product may be optionally heated in a pasteurization step prior to packing the dairy product composition. In some embodiments, the milling process and a pasteurizing step can be performed in any order, and may be performed simultaneously. The optional pasteurization step may aid in improving the shelf life of the final dairy product composition.

After the mixture is milled and optionally heated, the resulting final dairy product composition may be packaged, cased, and refrigerated for storage, distribution, and sale to customers. The dairy product composition can be used in a variety of edible dairy products, including but not limited to, spreads, ice cream, donuts, pastries, bagels, yogurts, shakes, high protein nutritional supplements, and the like. The dairy product composition may comprise a smooth, creamy, spreadable and fully homogenized composition having no visible curds. In some cases, the use of the cottage cheese as the curd component in the process described herein may result in a relatively high protein product, with a relatively low fat content. For example, the resulting dairy product composition may have a protein content greater than about 10.0%

In some cases, the dairy product composition can be produced using a process comprising a secondary milling process. The secondary milling process may provide a fully homogenized composition having no visible curds. In one embodiment, a process for producing a cream substitute comprises combining a cottage cheese and milk to form a mixture, passing the mixture through a secondary shearing pump, mill, or colloid mill to reduce the curd size, and packaging the resulting dairy product composition. The mixture may be optionally heated to a temperature and for a time sufficient to pasteurize the mixture to form a spreadable and fully homogenized dairy product.

In one embodiment, the process of producing a dairy product composition of the present disclosure comprises providing cottage cheese as the source of the curd component and a milk as the source of the softening agent. The cottage cheese can be manufactured using any of the processes described above and known in the art. For example, the cottage cheese can be produced using acidified milk, cultured milk, a milk coagulator, and/or a centrifugal separation. The resulting cottage cheese curds can be drained and/or pressed. If the cottage cheese curds are drained but not pressed, some of the whey may remain in the cottage cheese. The moisture provided by the whey may be taken into consideration in determining the amount of milk that is combined with the cottage cheese. In some embodiments, the cottage cheese curds can be pressed to remove an additional amount of the whey from the cottage cheese curds. In some embodiments, the cottage cheese curds can be optionally creamed prior to being used to form the diary product.

The milk used as the softening agent to form the dairy product compositions of the present disclosure may include any of the types of milk described herein. In some embodiments, the milk may comprise whole milk and/or a reduced fat milk such skim milk, 1% milk, 2% milk, and the like. Milk is a mixture of proteins of casein and whey proteins. Milk obtained by milking one or more cows is referred to as “cow's milk.” Cow's milk, whose composition has not been adjusted, is referred to herein as “whole milk,” and is generally comprised of casein, whey proteins, lactose, minerals, butterfat (milkfat), and water. The composition of the milk can be adjusted by removing one or more components of whole milk, and/or adding one or more components to the whole milk. The term “whole milk” is applied to milk that contains at least 3.25% fat. The term “skim milk” is applied to milk from which enough milkfat has been removed to reduce the milkfat content to less than 0.5 percent by weight (e.g., less than about 0.1%). The term “low fat milk” (or “part-skim milk”) is applied to milk from which enough milkfat has been removed to reduce the milkfat content to the range from about 0.5% to about 2.0%. Low-fat milk includes both 1% and 2% milk. In some embodiments, milkfat or other components can be added to whole milk. In other embodiments, the whole milk can be concentrated, for example, by removing a portion of the water, or dried. Water can then be added at a later time to reconstitute the milk. Accordingly, the term “milk” as used herein includes, among others, whole milk, low fat milk, (part-skim milk), skim milk, reconstituted milk, recombined milk, and whole milk whose content has been adjusted. While cow's milk is described herein, the term “milk” may also refer to milk obtained from other species including, but not limited to, sheep, goat, camel, and mixtures thereof.

The amount of milk used to produce the dairy product can be determined based on a variety of the factors. For example, the amount and/or type of milk in the final product can be based on the desired fat level in the final product, the characteristics of the cottage cheese (e.g., the moisture content, amount of whey, etc.) used in the process, and/or the desired characteristics in the final product (e.g., texture, thickness, etc.). In an embodiment, the final dairy product may comprise between about 1% and about 98% milk, or between about 51% and about 95% milk.

In some cases, the cottage cheese used in the mixture may comprise a single type of cottage cheese or a mixture of cottage cheeses (e.g., different fat contents, etc.) can be used. When more than one type of cottage cheese is used, the cottage cheese can be combined together or mixed in a plurality of mixing steps, prior to being combined with a softening agent. When a single type of cottage cheese is used, the cottage cheese can be separated into portions or provided as individual portions to be combined with the milk in different mixing stages. In some embodiments, the mixing stages can be separated by different milling stages.

In other cases, the milk used in the mixture can comprise one or types of milk. For example, the milk may comprise a blend of whole milk and reduced fat milk to provide the desired fat content. In some embodiments, different portions of the milk can be mixed with the cottage cheese at different points in the process. For example, a first portion of whole milk can be mixed with some or all of the cottage cheese in a first mixing step followed by milling of the mixture. A second portion of reduced fat milk could then be combined with the resulting milled product and mixed to form the final, fully homogenized dairy product.

In one embodiment, a mix is provided from milk and cottage cheese (e.g., including cottage cheese curd and some whey). The mix can be processed to produce a fully homogenized, spreadable composition with no visible cheese curds. A number of processing steps can be used to mill the mixture and reduce the cheese curd size including using a shearing pump, mill, or colloid mill. The milling step may be sufficient to reduce the curd size of the cottage cheese while not directly homogenizing the final product. The use of the cottage cheese may result in a relatively high protein product. For example, the resulting product may have a protein content of greater than 10.0%

In some cases, the cottage cheese curd can be creamed to produce the final dairy product composition. The creaming process generally involves the addition of cream and/or milk in various forms to the cottage cheese curds. The cream and/or milk may be pasteurized prior to being combined with the cottage cheese curds and/or the creamed mixture can be pasteurized after mixing. Various additional ingredients can be combined with the cottage cheese prior to forming the cottage cheese product that is used in forming the diary product of the present disclosure. In some embodiments, the cottage cheese curds may be used without creaming as the cottage cheese in the dairy product composition of the present disclosure.

The amount of the curd component used to produce the dairy product composition of the present disclosure can be determined based on a variety of the factors. For example, the amount of the curd component used can be based on the desired protein range in the final diary product composition, the desired fat level in the final diary product composition, the desired nutritional characteristics of the curd component used in the process, and/or the desired organoleptic properties (e.g., texture) in the final diary product composition. While the milk used as a softening agent in the processes described herein may contribute to a portion of the protein and fat contend of the final dairy product, the curd component (e.g., cottage cheese curd) may contribute the majority of the protein and fat. As a result, the moisture, fat, and protein content of the curd component may be relevant factors in determining the composition of the mixture used to make the final dairy product composition.

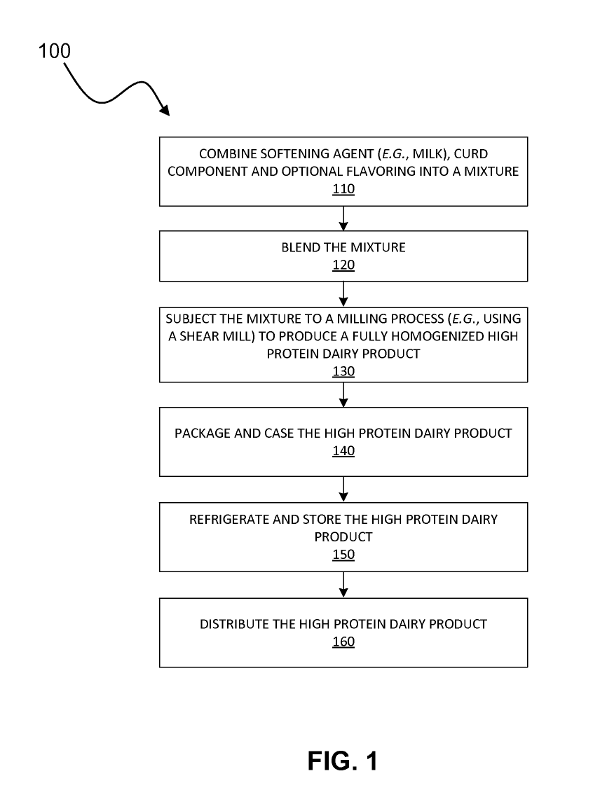

FIG. 1 is a representative flow diagram of a method of producing a high protein dairy product (100), according to one embodiment of the present disclosure. According to this embodiment, the method includes combining one or more softening agents (e.g., milk) with a curd component (110) to form a mixture. In some cases, additional components are added to the mixture, including but not limited to, gums, texturizing agents, mouth coating agents, emulsifiers, thickening agents, coloring agents, fat sources, flavorings (natural or artificial), preservatives, bulking agents, acidity regulators, fillers, vitamins, minerals, nutritional supplements, and the like. The mixture is then blended (120) prior to subjecting the mixture to a milling process (130). The milling process includes subjecting the mixture of the curd component and the softening agent to shear stress to produce a fully homogenized dairy product composition having high protein content. In some cases, the milling process includes subjecting the mixture to temperatures between about 30° F. and about 150° F., and to pressures between about 100 psi and about 5,000 psi. After the milling process is complete, the resulting dairy product composition is packaged and/or cased (140). The dairy product composition can also be refrigerated and stored (150) and/or distributed and sold to customers (160).

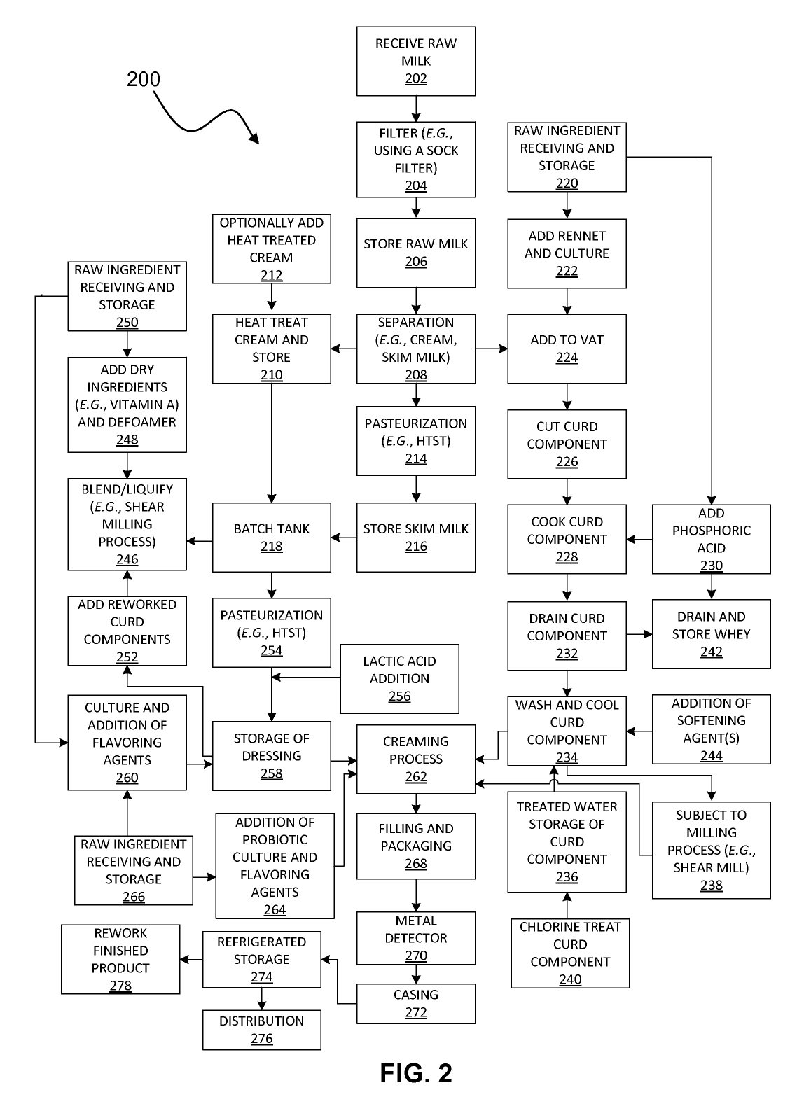

FIG. 2 is a representative flow diagram of a detailed production process for generating a high protein dairy product from curd (200), according to one embodiment of the present disclosure. According to this embodiment, the process includes receiving raw milk (202), and filtering the milk using, for example, a sock filter (204). In some cases, the filtered raw milk is stored (206) until further processing. In other cases, the filtered raw milk is directly subjected to a separation process (208), for example, to separate the cream from the skim milk. The skim milk portion can be pasteurized using, for example, a high temperature, short time process (HTST) (214), and subsequently stored (216). The cream portion can be heat-treated and subsequently stored (210) and/or placed in a batch tank (218) for further processing, in some cases, along with the milk portion (216). Optionally, exogenous heat-treated cream can be added to the stored cream portion (212) before entering the batch tank.

Also shown in FIG. 2, the milk and/or cream portions can be sent to a raw ingredient receiving and storage container (220) from which a curd component can be generated. In some cases, rennet can be added to the milk and/or cream portions to facilitate the precipitation of casein to form the curd component 222. The curd component can be stored in a vat 224 prior to cutting 226, cooking 228, and draining 232. In some cases, phosphoric acid can be added to the curd component during the cooking process 230. Draining the curd component typically includes draining the whey portion that remains soluble in liquid form (242). After draining, the curd component can be washed and cooled (234) and a softening agent can be added (244). In some cases, the curd component and/or the softening agent can be water-treated (236) and/or treated with chlorine (240). The mixture of the curd component and the softening agent can then be subject to shear stress (e.g., a shear mill) to reduce the density of the curd component and to generate a fully homogenized, high protein dairy product (238).

Also shown in FIG. 2, the milk and/or cream portions in the batch tank (218) can be blended and/or liquefied, and/or subjected to a milling process (246). In some cases, the milk and/or cream portions can be blended and/or liquefied after the addition of other raw ingredients from the receiving and storage container (250). In other cases, dry ingredients, such as vitamin A and a defoamer can be added to the milk and/or cream portions prior to blending (248). In still other embodiments, reworked curd components can be added to the milk and/or cream portions prior blending (252).

The milk and/or cream portions in the batch tank (218) can also undergo pasteurization (e.g., HTST pasteurization) (254). Lactic acid can be added as well (256), prior to storage of the dressing (258). In some cases, culturing and the addition of various flavoring agents can be added to the dressing (260), with or without the addition of raw ingredients from the receiving and storage container (250 and/or 266). In some cases, the dressing can enter a creaming process (262) in which washed and cooled curd components (234) as well as other agents, such as flavoring agents and probiotic cultures (264), are combined into a mixture. In other cases, the mixture of the curd component and the softening agent that was subjected to a milling process (238) can enter the creaming process (262).

In either case, the resultant dairy product compositions can be filled with various components and/or packaged (268). The dairy product compositions can be sent through a metal detector to detect and remove contaminants (270), and/or enter a casing process (272) prior to being refrigerated and stored (274), reworked into a variety of other products (e.g., donuts) (278), and/or distributed to customers (276).

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent.

Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

The present disclosure, in various aspects, embodiments, and configurations, includes components, methods, processes, systems and/or apparatus substantially as depicted and described herein, including various aspects, embodiments, configurations, sub combinations, and subsets thereof. Those of skill in the art will understand how to make and use the various aspects, aspects, embodiments, and configurations, after understanding the present disclosure. The present disclosure, in various aspects, embodiments, and configurations, includes providing compositions and processes in the absence of items not depicted and/or described herein or in various aspects, embodiments, and configurations hereof, including in the absence of such items as may have been used in previous compositions or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

### EXAMPLES

### Measurement of Unstirred Viscosity

As shown in Table 2 (below), various high protein dairy product compositions of the present disclosure were generated according to the various parameters listed (i.e., Factors 1, 2, and 3). Unstirred viscosity (i.e., viscosity measured without stirring the final product) was then measured for each different dairy product composition. Factor 1=Rotor Speed (Hz); Factor 2=Flow Aid (e.g., softening agent) Percentage; Factor 3=Rotor Setup (e.g., milling pore size). The shear milling process used to generate the various dairy product compositions was performed with a FLOWSHEAR device (FS-900) from ADMIX.

Generally, these data suggest that the viscosities of the dairy product compositions can be lowered by using a lower percentage of skim milk as the softening agent, and/or by using a shear milling rotor setup having a Medium/Fine/Very Fine pore size.

TABLE 2
Viscosity Measurements Without Stirring

| | | Factor 1 | | | Response 1 | | | | | | |
|---|---|---|---|---|---|---|---|---|---|---|---|
| Exp. | | Rotor | Factor 2 | Factor 3 | Viscosity | Time (seconds) | | | | | |
| No. | Run | Speed | Flow Aids | Rotor Set-Up | Avg cPs | 10 s | 20 s | 30 s | 40 s | 50 s | 60 s |
| 1 | 9 | 45 Hz | 37.5% skim | Blank, Ripper, Coarse | 190000 | 191000 | 199000 | 195000 | 193000 | 179000 | 183000 |
| 2 | 4 | 45 Hz | 37.5% skim | Medium, Fine, Very Fine | 149666.667 | 141000 | 162000 | 151000 | 145000 | 149000 | 150000 |
| 3 | 7 | 45 Hz | 28.5% skim | Blank, Ripper, Coarse | 312666.667 | 260000 | 291000 | 314000 | 354000 | 342000 | 315000 |
| 4 | 10 | 60 Hz | 37.5% skim | Blank, Ripper, Coarse | 190833.333 | 201000 | 181000 | 202000 | 192000 | 188000 | 181000 |
| 5 | 3 | 60 Hz | 28.5% skim | Medium, Fine, Very Fine | 348166.667 | 333000 | 351000 | 341000 | 361000 | 351000 | 352000 |
| 6 | 1 | 45 Hz | 16.6% skim | Medium, Fine, Very Fine | 448333.333 | 421000 | 455000 | 458000 | 464000 | 449000 | 443000 |
| 7 | 2 | 45 Hz | 28.5% skim | Medium, Fine, Very Fine | 393166.667 | 339000 | 380000 | 419000 | 395000 | 410000 | 416000 |
| 8 | 5 | 60 Hz | 37.5% skim | Medium, Fine, Very Fine | 156333.333 | 158000 | 172000 | 151000 | 166000 | 152000 | 139000 |
| 9 | 8 | 60 Hz | 28.5% skim | Blank, Ripper, Coarse | 369166.667 | 374000 | 387000 | 361000 | 354000 | 366000 | 373000 |
| 10 | 6 | 45 Hz | 16.6% skim | Blank, Ripper, Coarse | 661500 | 700000 | 673000 | 632000 | 657000 | 665000 | 642000 |

### Measurement of Stirred Viscosity

As shown in Table 3 (below), various high protein dairy product compositions of the present disclosure were generated according to the various parameters listed (i.e., Factors 1, 2, and 3). Stirred viscosity (i.e., viscosity measured after stirring the final product) was then measured for each different dairy product composition. Factor 1=Rotor Speed (Hz); Factor 2=Flow Aid (e.g., softening agent) Percentage; Factor 3=Rotor Setup (e.g., milling pore size). The shear milling process used to generate the various dairy product compositions was performed with a FLOWSHEAR device (FS-900) from ADMIX.

Similar to measurements of unstirred viscosity, these data suggest that the viscosities of the dairy product compositions can be lowered by using a lower percentage of skim milk as the softening agent, and/or by using a shear milling rotor setup having a Medium/Fine/Very Fine pore size.

TABLE 3
Viscosity Measurements After Stirring

| | | Factor 1 | | | Response 1 | | | | | | |
|---|---|---|---|---|---|---|---|---|---|---|---|
| Exp. | | Rotor | Factor 2 | Factor 3 | Viscosity | Time (seconds) | | | | | |
| No. | Run | Speed | Flow Aids | Rotor Set-Up | Avg cPs | 10 s | 20 s | 30 s | 40 s | 50 s | 60 s |
| 1 | 9 | 45 Hz | 37.5% skim | Blank, Ripper, Coarse | 73000 | 67000 | 69000 | 77000 | 73000 | 74000 | 78000 |
| 2 | 4 | 45 Hz | 37.5% skim | Medium, Fine, Very Fine | 53000 | 52000 | 53000 | 51000 | 55000 | 52000 | 55000 |
| 3 | 7 | 45 Hz | 28.5% skim | Blank, Ripper, Coarse | 133000 | 126000 | 127000 | 133000 | 138000 | 143000 | 131000 |
| 4 | 10 | 60 Hz | 37.5% skim | Blank, Ripper, Coarse | 64167 | 62000 | 72000 | 68000 | 62000 | 53000 | 68000 |
| 5 | 3 | 60 Hz | 28.5% skim | Medium, Fine, Very Fine | 122333 | 109000 | 112000 | 114000 | 123000 | 131000 | 145000 |
| 6 | 1 | 45 Hz | 16.6% skim | Medium, Fine, Very Fine | 190000 | 183000 | 179000 | 180000 | 193000 | 201000 | 204000 |
| 7 | 2 | 45 Hz | 28.5% skim | Medium, Fine, Very Fine | 174000 | 153000 | 155000 | 158000 | 175000 | 200000 | 203000 |
| 8 | 5 | 60 Hz | 37.5% skim | Medium, Fine, Very Fine | 53500 | 44000 | 49000 | 52000 | 55000 | 61000 | 60000 |
| 9 | 8 | 60 Hz | 28.5% skim | Blank, Ripper, Coarse | 145167 | 135000 | 143000 | 147000 | 150000 | 147000 | 149000 |
| 10 | 6 | 45 Hz | 16.6% skim | Blank, Ripper, Coarse | 292167 | 288000 | 291000 | 273000 | 302000 | 291000 | 308000 |

### Change in Viscosity (Delta Viscosity)

Table 4 (below) lists the changes between the average viscosities (delta viscosity) of the unstirred and corresponding stirred dairy product compositions tested in Tables 2 and 3 (above). Generally, stirred viscosity measurements were lower, between about 55% and about 67%, as compared to unstirred viscosity measurements.

TABLE 4
Delta Viscosity

| | | | | Factor 3 | Delta | |
|---|---|---|---|---|---|---|
| Exp. | | Factor 1 | Factor 2 | C: Rotor/Stator | Viscosity | % Change Due |
| No. | Run | A: Rotor/S [symbol] | B: Flow Aids | Set-Up | Avg cPs | to Stirring |
| 1 | 9 | 45 Hz | 37.5% skim | Blank, Ripper, Coarse | 117000 | 61.6% |
| 2 | 4 | 45 Hz | 37.5% skim | Medium, Fine, Very Fine | 96667 | 64.6% |
| 3 | 7 | 45 Hz | 28.5% skim | Blank, Ripper, Coarse | 179667 | 57.5% |
| 4 | 10 | 60 Hz | 37.5% skim | Blank, Ripper, Coarse | 126667 | 66.4% |
| 5 | 3 | 60 Hz | 28.5% skim | Medium, Fine, Very Fine | 225833 | 64.9% |
| 6 | 1 | 45 Hz | 16.6% skim | Medium, Fine, Very Fine | 258333 | 57.6% |
| 7 | 2 | 45 Hz | 28.5% skim | Medium, Fine, Very Fine | 219167 | 55.7% |
| 8 | 5 | 60 Hz | 37.5% skim | Medium, Fine, Very Fine | 102833 | 65.8% |
| 9 | 8 | 60 Hz | 28.5% skim | Blank, Ripper, Coarse | 224000 | 60.7% |
| 10 | 6 | 45 Hz | 16.6% skim | Blank, Ripper, Coarse | 369333 | 55.8% |

[symbol]

indicates data missing or illegible when filed

### Measurement of Density

As shown in Table 5 (below), various high protein dairy product compositions of the present disclosure were generated according to the various parameters listed (i.e., Factors 1, 2, and 3). Density was then measured for each different dairy product composition. Factor 1=Rotor Speed (Hz); Factor 2=Flow Aid (e.g., softening agent) Percentage; Factor 3=Rotor Setup (e.g., milling pore size). The shear milling process used to generate the various dairy product compositions was performed with a FLOWSHEAR device (FS-900) from ADMIX.

Generally, these data suggest that the densities of the dairy product compositions can be controlled using various combinations of rotor setup, rotor speed, and percentages of softening agents.

TABLE 5
Density

| | | Factor 1 | Factor 2 | Factor 3 | | | | |
|---|---|---|---|---|---|---|---|---|
| Exp. | | Rotor | Flow | Rotor | Density | Density | Weight | Weight per |
| No. | Run | Speed | Aids | Set-Up | (g/mL) | (lb/gal) | (g) | serving (g) |
| 1 | 9 | 45 Hz | 37.5% skim | Blank, Ripper, Coarse | 0.83 | 6.93 | 6.99 | 124.56 |
| 2 | 4 | 45 Hz | 37.5% skim | Medium, Fine, Very Fine | 0.68 | 5.69 | 5.74 | 102.29 |
| 3 | 7 | 45 Hz | 28.5% skim | Blank, Ripper, Coarse | 0.85 | 7.09 | 7.15 | 127.41 |
| 4 | 10 | 60 Hz | 37.5% skim | Blank, Ripper, Coarse | 0.74 | 6.20 | 6.25 | 111.38 |
| 5 | 3 | 60 Hz | 28.5% skim | Medium, Fine, Very Fine | 0.82 | 6.88 | 6.94 | 123.67 |
| 6 | 1 | 45 Hz | 16.6% skim | Medium, Fine, Very Fine | 0.88 | 7.32 | 7.38 | 131.51 |
| 7 | 2 | 45 Hz | 28.5% skim | Medium, Fine, Very Fine | 0.78 | 6.50 | 6.56 | 116.90 |
| 8 | 5 | 60 Hz | 37.5% skim | Medium, Fine, Very Fine | 0.83 | 6.92 | 6.98 | 124.38 |
| 9 | 8 | 60 Hz | 28.5% skim | Blank, Ripper, Coarse | 0.88 | 7.38 | 7.44 | 132.58 |
| 10 | 6 | 45 Hz | 16.6% skim | Blank, Ripper, Coarse | 0.83 | 6.95 | 7.01 | 124.92 |

### Sample Formulations

Table 6 (below) lists five separate sample formulations of the high protein dairy product composition of the present disclosure, which were used for consumer focus group studies. The milling process settings used to generate the compositions are also listed.

TABLE 6
Sample Formulations

| | Sample | | | | | |
|---|---|---|---|---|---|---|
| | Sample 5 | Sample 3 | Sample 1 | Sample 5 | Sample 3 | Sample 1 |
| | unflavored | unflavored | unflavored | Vanilla | Vanilla | Vanilla |
| ID | 947 | 713 | 321 | 122 | n/a | n/a |
| Formula | | | | | | |
| Curd (lbs) | 15.6 | 35.7 | 20.9 | 13.9 | 16.22 | 19.31 |
| Skim Milk (lbs) | 9.4 | 14.3 | 4.15 | 9.27 | 6.95 | 3.86 |
| Sugar (lbs) | 0 | 0 | 0 | 1.5 | 1.5 | 1.5 |
| Vanilla (lbs) | 0 | 0 | 0 | 0.325 | 0.325 | 0.325 |
| Total | 25 | 50 | 25.05 | 24.995 | 24.995 | 24.995 |
| Formula | | | | | | |
| Curd (%) | 62.4% | 71.4% | 83.4% | 55.6% | 64.9% | 77.3% |
| Skim Milk (%) | 37.6% | 28.6% | 16.6% | 37.1% | 27.8% | 15.4% |
| Sugar (%) | 0.0% | 0.0% | 0.0% | 6.0% | 6.0% | 6.0% |
| Vanilla (%) | 0.0% | 0.0% | 0.0% | 1.3% | 1.3% | 1.3% |
| Settings | | | | | | |
| Liquifier speed (rpm) | 600 | 600 | 600 | 600 | 600 | 600 |
| Time in liquifier (min) | 5 | 5 | 5 | 5 | 5 | 5 |
| Pump setting (Hz) | 6 | 6 | 6 | 6 | 6 | 6 |
| Mill setting (Hz) | 60 | 60 | 60 | 60 | 60 | 60 |
| Mill set-up | Med, Fine, | Med, Fine, | Med, Fine, | Med, Fine, | Med, Fine, | Med, Fine, |
| | Very Fine | Very Fine | Very Fine | Very Fine | Very Fine | Very Fine |

As demonstrated by the above Examples, the various organoleptic characteristics (e.g., viscosity, density, texture, etc.) of the high protein dairy product compositions disclosed herein can be controlled by varying, for example, the amount of the softening agent used and the milling parameters, such as the rotor setup and speed. This flexibility allows for the creation of high protein dairy product compositions that can meet a wide range of consumer demand, and can be incorporated into a wide range of consumer products.

The above examples, embodiments, definitions and explanations should not be taken as limiting the full metes and bounds of the invention. The present disclosure, in various aspects, embodiments, and configurations, includes components, methods, processes, systems and/or apparatus substantially as depicted and described herein, including various aspects, embodiments, configurations, sub combinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A high-protein dairy product composition comprising:
at least one curd component comprising curds with particle sizes between 0.1 mm to 3.0 mm in diameter, and a protein content greater than 10%; and
at least one softening agent having a viscosity less than 300,000 centipoise;
wherein the at least on softening agent and the at least one curd component are combined into a mixture and milled to produce an homogenized dairy product composition having a protein content greater than 5%, curds with particle sizes less than 100 μm, and an overrun less than 50%.

2. The composition of claim 1, wherein the curd component has a protein content between 10% and 25%.

3. The composition of claim 1, wherein the curd component has a whey content that is not greater than 50%.

4. The composition of claim 1, wherein the curd component has a fat content that is not greater than 5%.

5. The composition of claim 1, wherein the curd component has a density between 7.0 lbs/gal and 10.0 lbs/gal.

6. The composition of claim 1, wherein the curd component has a pH between 4.0 and 6.0.

7. The composition of claim 1, wherein the curds of the curd component comprise precipitated casein.

8. The composition of claim 1, wherein the softening agent has a protein content between 0% and 50%.

9. The composition of claim 1, wherein the softening agent has a density between 5.0 lbs/gal and 15.0 lbs/gal.

10. The composition of claim 1, wherein the softening agent has a pH between 2.0 and 9.0.

11. The composition of claim 1, wherein the softening agent comprises one or more of fruit juice, fruit preparation, milk, flavored milk, oils and fats.

12. The composition of claim 1, wherein the fully homogenized dairy product composition has a protein content between 5% and 20%.

13. The composition of claim 1, wherein the fully homogenized dairy product composition has a whey content that is not greater than 50%.

14. The composition of claim 1, wherein the fully homogenized dairy product composition has a fat content that is not greater than 4%.

15. The composition of claim 1, wherein the fully homogenized dairy product composition comprises curds with particle sizes less than 40 μm in diameter.

16. The composition of claim 1, wherein the fully homogenized dairy product composition has a protein-to-fat ratio between 1:0.001 to 1:1.

17. The composition of claim 1, wherein the fully homogenized dairy product composition has a density between 5.0 lbs/gal and 10.0 lbs/gal.

18. The composition of claim 1, wherein the fully homogenized dairy product composition has a pH between 4.0 and 6.0.

19. The composition of claim 1, wherein the fully homogenized dairy product composition comprises precipitated casein.

20. The composition of claim 1, wherein the fully homogenized dairy product composition further comprises one or more of gums, texturizing agents, mouth coating agents, emulsifiers, thickening agents, coloring agents, fat sources, flavorings (natural or artificial), preservatives, bulking agents, acidity regulators, fillers, vitamins, minerals and nutritional supplements.

21. A method of producing a homogenized dairy product, the method comprising:
combining at least one curd component comprising curds with particle sizes between 0.1 mm to 3.0 mm in diameter, and a protein content greater than 10%, with at least one softening agent having a density less than 300,000 centipoise to form a mixture;
subjecting the mixture to a milling process sufficient to produce a fully homogenized diary product having a protein content greater than 5% and an overrun less than 50%.

22. The method of claim 21, wherein the milling process comprises subjecting the mixture of the at least one curd component and the at least one softening agent to shear stress.

23. The method of claim 21, wherein the milling process comprises subjecting the mixture of the at least one curd component and the at least one softening agent to temperatures between 30° F. and 150° F.

24. The method of claim 21, wherein the milling process comprises subjecting the mixture of the at least one curd component and the at least one softening agent to pressures between 100 psi and 5,000 psi.
